(19) United States
(12) Patent Application Publication
(10) Pub. No.: US 2005/0218541 A1
(43) Pub. Date: Oct. 6, 2005

(54) Method of producing interpenetrating polymer network

(76) Inventors: Henry Tao Peng, Richmond Hill (CA); Michelle Mok, Markham (CA); Lucie Martineau, Kettleby (CA); Pang N. Shek, Toronto (CA)

Correspondence Address: GEORGE A. SEABY;SEABY & ASSOCIATES, 250 CITY CENTRE AVNUE, OTTAWA, ON, K1R6K7, CA

(21) Appl. No.: 10/815,715

(22) Filed: Apr. 2, 2004

(51) Int. Cl. B05B 3/00

(52) U.S. Cl. 264/28

(57) ABSTRACT

A two component interpenetrating polymer network (IPN) wound dressing material is formed of a biocompatible, hydrophilic first component such as gelatin or polyvinyl alcohol and a biocompatible elastomer such as HydroThane (trademark) by dissolving the components in a common solvent, initiating cross-linking of at least one of the components in the solution, and forming a film, fiber, bead or mesh from the solution. When the first component is a methacrylated gelatin aged for an extended period, e.g. 1 to 8 weeks, the resulting IPN is more stable with a higher tensile strength. Heating of the methacrylated gelatin during aging and/or freeze-drying of the product also increase tensile strength of the product.

### BACKGROUND OF THE INVENTION

1. Field of the Invention

This invention relates to a method of producing an interpenetrating polymer network.

In particular, the invention relates to a method of producing a hydrogel-elastomer interpenetrating polymer network (IPN) intended for use as a wound dressing. Interpenetrating polymer networks (IPNs) are defined as a combination of two cross-linked polymers, at least one of them synthesized or cross-linked in the immediate presence of the other. IPNs are distinguishable from blends, block copolymers and graft copolymers by (1) their ability to swell but not dissolve in solvents, and (2) suppression of their creep and flow. The preferred components of the IPN are (1) a hydrophilic biopolymer such as gelatin, chitosan, alginate or oxidized cellulose or a synthetic hydrogel such as polyvinyl alcohol, and (2) an elastomer such as a modified polyurethane. The IPN can be in the form of a film, fiber, sponge or mesh.

2. Discussion of the Prior Art

Some of the inventors were involved in an earlier effort to prepare a wound dressing pad, many of which are described in the patent literature. Typical wound dressings include cotton gauze, coated nylon or polyethylene mesh. Fibers used in wound dressings include alginate, keratin and silver impregnated polyamide fibers. U.S. Pat. No. 5,676,967 discloses an aqueous combination of collagen and oligosaccharide coating on the surface of a polyethylene mesh. The mesh is used in a single layer to cover ulcers and burns. U.S. Pat. No. 6,123,958 discloses a non-reinforced, apertured gel web prepared from a water-soluble polysaccharide or cellulosic-polymer for treating burns. U.S. Pat. No. 5,961,478 relates to a super absorbent fiber consisting of polyacrylonitrile for use in wound dressings. Sorbsan (trademark) dressings (Pharma-Plast Ltd., Steriseal Division) are made of calcium alginate fibers with a non-woven structure, which maximizes absorption of wound exudate. The fibers of Sorbsan swell to form a soft, amorphous sodium-calcium alginate gel. Sorbsan is made from the calcium salt of alginic acid, prepared as a textile fiber, and presented as a loose ‘rope’ or packing for cavities, a ribbon for narrow wounds or sinuses, and a flat non-woven pad for application to larger open wounds. When in contact with serum, wound exudate or solutions containing sodium ions, the insoluble calcium alginate is partially converted to the soluble sodium salt, and a hydrophilic gel is produced, which overlays the wound and provides a micro-environment that is believed to facilitate wound healing. Sorbsan is indicated for moderate to high levels of exudates.

Fibracol (trademark) available from Johnson & Johnson Medical, Inc. is a 90% collagen-10% alginate wound dressing which combines the structural support of collagen and the gel forming properties of alginate into a soft and absorbent wound dressing.

In spite of the advances described above, there are certain significant aspects of wound dressings that do not appear to have been dealt with effectively. Deficiencies of some existing products include inadequate permeability to the outward passage of vapor from dressed wound sites, low absorption capacity, low hemostatic properties and a strong tendency to adhere to the biological elements of wounds during healing. This last factor involving attachment of wound dressings at a wound site results in damage to healing tissue during removal of dressings, thus prolonging overall healing.

Efforts to reduce such damage, e.g. by soaking off the attached material may have undesirable effects on biological healing elements involved with a wound. Other important aspects of such a situation are the pain and adverse psychological effects that such experiences produce. Another area of concern is that of deep wounds involving internal organs such as intestines, liver, spleen and lungs. When organs are damaged and hemorrhaging, the current medical treatment frequently involves packing the injured organ or the abdominal cavity with gauze to diminish and control bleeding. The gauze is usually coarse and can cause irritation and bruising, while also becoming attached to the wound.

As a result of the earlier efforts involving some of the present inventors, an IPN having low adhesion to biological tissues was produced. The object of the present invention is to provide an improved method of producing an IPN of the type in question.

### GENERAL DESCRIPTION OF THE INVENTION

Accordingly the invention relates to a method of producing an interpenetrating polymer network comprising the steps of:
forming a first solution of a biocompatible, hydrophilic first component selected from the group consisting of a biopolymer, a synthetic polymer and monomers and prepolymers of said biopolymer and synthetic polymer;
allowing said first solution of said first component to age for an extended period of time;
forming a second solution of aged first component and monomers and prepolymers of said biopolymer and synthetic polymer, and a second component selected from the group consisting of a biocompatible elastomer and monomers and prepolymers thereof in a common solvent; and
forming a film, fiber, bead or mesh from the second solution.

According to another aspect, the invention relates to an interpenetrating polymer network prepared by the above described method.

### DRAWING DESCRIPTION

In the accompanying drawings:

FIG. 1 is a series of micrographs showing the morphology of IPN films prepared from fresh and aged diluted (1 and 2 weeks) 18% methacrylated gelatin solutions;

FIG. 2 is a series of microphotographs showing the morphology of IPN films prepared from fresh and aged (4 and 8 weeks) 7.5% methacrylated gelatin solutions;

FIG. 3 is a graph showing the variation in hydration during a 40-day incubation period in 0.1% sodium azide aqueous solution of IPN films prepared from fresh or aged (1 to 7 weeks) methacrylated gelatin solutions;

FIG. 4 is a bar graph showing the variation in tensile strength of IPN films prepared from fresh or aged (1 to 7 weeks) 7.5 wt % methacrylated gelatin solutions;

FIG. 5 is a bar graph showing the variation in tensile strength due to freeze-drying of IPN films prepared from fresh or aged diluted 18 wt % methacrylated gelatin solutions; and

FIG. 6 is a bar graph of the variation of tensile strength of IPN films prepared from 7.5% methacrylated gelatin solutions aged at room temperature (block bars) or at 50° C. (hatched bars).

### DESCRIPTION OF THE PREFERRED EMBODIMENT

The hydrophilic first component is selected from the group consisting of polyvinyl alcohol, polyhydroxymethacrylate, polyethylene oxides, acrylamides, hydrophobically modified hydrogels, collagen, gelatin, fibronectin, cellulose, hydroxypropyl cellulose, hydroxypropylmethyl cellulose, methyl cellulose, ethyl cellulose, carboxymethyl cellulose, carboxyethyl cellulose, a modified gelatin, alginate and oxidized cellulose, the preferred component being gelatin or a modified gelatin, specifically methacrylated gelatin. This material is hydrophilic, absorbent, biocompatible and possesses known hemostatic properties. Thus, the incorporation of gelatin into a wound dressing for application to hemorrhagic living tissues would be expected to promote rapid hemostasis.

Suitable hydrophobic second components include polyurethane; elastomers, and siloxane polymers such as polydimethylsiloxanes or vinyl containing siloxanes or polymethylhydrosiloxanes, polyethylene-vinylacetate (EVA), polytetramethylene oxide (PTMO), and HydroThane. HydroThane is a trademark of Cardiotech International Inc. of Woburn, Mass. for a superabsorbent, thermoplastic hydrophilic, aliphatic polyurethane elastomer. The particular product used in the present case is identified as HydroThane AR25-80A.

Common solvents for the two polymer components along with co-solvents, emulsifiers and smaller molecular weight polymers are used to increase the solubility of the two components in a compatible solvent to a functional level. One of the more important aspects of preparing hydrogel-elastomer IPN is finding a common solvent for the two components. When gelatin is used as the biopolymer component of the IPN, suitable solvents include glycerol, water, trifluoroethane and acetic acid. N-methylformamide, dimethylsulfoxide, formamide, acetamide, thioacetamide, propionamide, 2-pyrrolidinone, N-ethylurea, urea and thiourea derivatives also dissolve gelatin.

A co-solvent may be used to dissolve the first and second component in the common solvent. Suitable co-solvents include organic, nonpolar solvents such as cyclohexane, chloroform, benzene, toluene, methylene chloride, chlorobenzene, chlorotoluene, methyl ethyl ketone, cyclic aromatics and halogenated cyclic aromatics, dimethylacetamide or N-methylpyrrolidone.

Drugs or active ingredients may be introduced into the solution at this point providing that the drug or active ingredient is not adversely affected by the solvents or temperatures used to prepare the materials.

Ideally, the cross-linking reaction for the preparation of IPNs should be fast so that crosslinks are formed before phase separation begins to occur. The cross-link reaction rate may be increased by elevating the temperature or concentrations of the reagents. Once the cross-linking reaction has taken place the IPN may be washed for up to two weeks with water or solvent to fully remove all reagents and unreacted polymer materials.

During the preparation of IPN fibers consisting of gelatin-elastomer, cross-linking of the gelatin component may also only be effected once the fibers have been formed. Fibers may be formed individually using apparatus similar to a hypodermic needle where the solution is loaded into the barrel and the plunger is depressed at a slow rate to form a fiber. Heat or UV light may be used to cross-link the polymer components as the fiber is formed.

Drugs may be incorporated into the IPN via dispersion, dissolution, absorption or chemical linkage depending upon the method used to combine the two polymers as well as the solubility properties of the drug. In the case of a gelatin-HydroThane film, drugs may be dissolved or dispersed in the gelatin-HydroThane reaction mixture prior to cross-linking of the gelatin or a solution of the drug can be absorbed into the finished IPN material.

The IPN is formed into a film, fiber, sponge (open cell structure) or a mesh for use in a wound dressing. The IPN can also be used in the cosmetic industry.

The following example further illustrates the method of the present invention.

### EXAMPLE

Methacrylation of Gelatin

10 g of gelatin Type A Bloom 235 available form Great Lake Gelatin (Grayslake Ill.) was added to 100 mL of phosphate buffered saline (PBS, pH 7.4) and the mixture was stirred at 50° C. until complete dissolution. A 0.5 mL aliquot of 94% methacrylic anhydride was added to the gelatin solution. The reaction mixture was stirred for 60 min at approximately 50° C., and dialysed against distilled water at room temperature for one week before freeze-drying for 4 to 6 days. The dialysis membranes that were used had a molecular weight cut-off of 12000-14000.

Preparation of Fresh and Aged Methacrylated Gelatin Solution in DMSO

A 7.5 wt % methacrylated gelatin solution was prepared in DMSO (hereinafter referred to as ‘fresh’ methacrylated gelatin) and immediately used for preparation of an interpenetrating polymer network (IPN). Another batch of 7.5 wt % of methacrylated gelatin solution was prepared in DMSO and (a) left at room temperature for 1 to 8 weeks in a sealed scintillation vial (i.e. no nitrogen protection) or (b) heated at 50° C. for 3 to 24 days in a sealed scintillation vial. Both solutions are referred to herein as ‘aged’ methacrylated gelatin. In addition, an 18 wt % DMSO solution of methacrylated gelatin was prepared and aged at room temperature for 1 to 3 weeks. The solution was then diluted to 7.5% in DMSO for IPN preparation.

This solution is referred herein as ‘aged diluted’ methacrylated gelatin.

Preparation of Gelatin HydroThane IPN

A 0.67 g sample of aged 7.5 wt % methacrylated gelatin in DMSO was mixed with 1.25 g of 4 wt % HydroThane in DMSO in a scintillation vial. A 91 μl aliquot of 10 wt % 2,2-dimethoxy-2-phenylacetophenone (available from Ciba Specialty Chemicals Canada of Toronto, Ontario under the trademark Irgacure 651) in DMSO was then added. The mixture was vigorously vortexed for about 30 s, and purged with nitrogen for 5 minutes in the scintillation vial. The mixture was UV-irradiated for 15 min at 350 nm at an intensity of 9 m W/cm² (using a RAYONET model RPR-200, Southern New England Company, Brandford, CN) to form an IPN film. The resulting film was washed for a week in a 0.1% aqueous solution of sodium azide solution to remove all residual DMSO. Some of the IPN films were then frozen at −70° C. and dried under vacuum.

Imaging Analysis of Domain Size of IPN Films

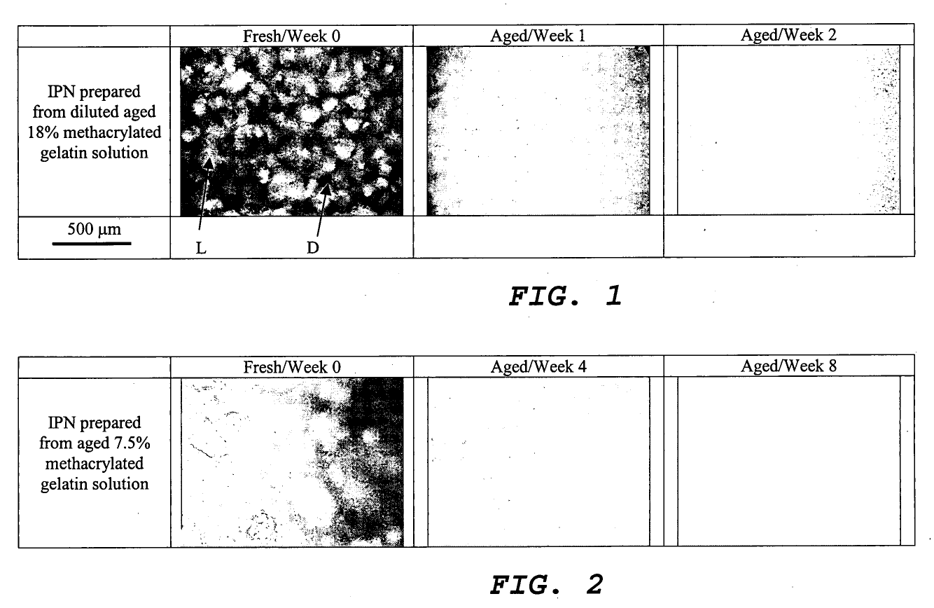

The images of the gelatin-HydroThane IPN films shown in FIGS. 1 and 2 were taken using a digital camera (Nikon CoolPix™ 880) positioned over the eyepiece of an optical microscope (Olympus BH-2) set at 100× magnification. The camera output was routed to a 14-inch television monitor (Sony Trinitron) to focus the images.

FIGS. 1 and 2 illustrate the changes in the morphology of IPN films prepared using fresh (i.e. no aging) and aged (for up to 8 weeks) methacrylated gelatin solutions of different concentrations (7.5% and 18%). The darker areas (D) are HydroThane polymer and the lighter areas (L) are methacrylated gelatin. It will be noted that the domain size of each component is reduced as the storage period (aging) of the methacrylated gelatin solution is increased prior to its use in preparing an IPN, irrespective of the initial concentration of the gelatin solution. Furthermore, it appears that the aging process is accelerated when using a more concentrated gelatin solution.

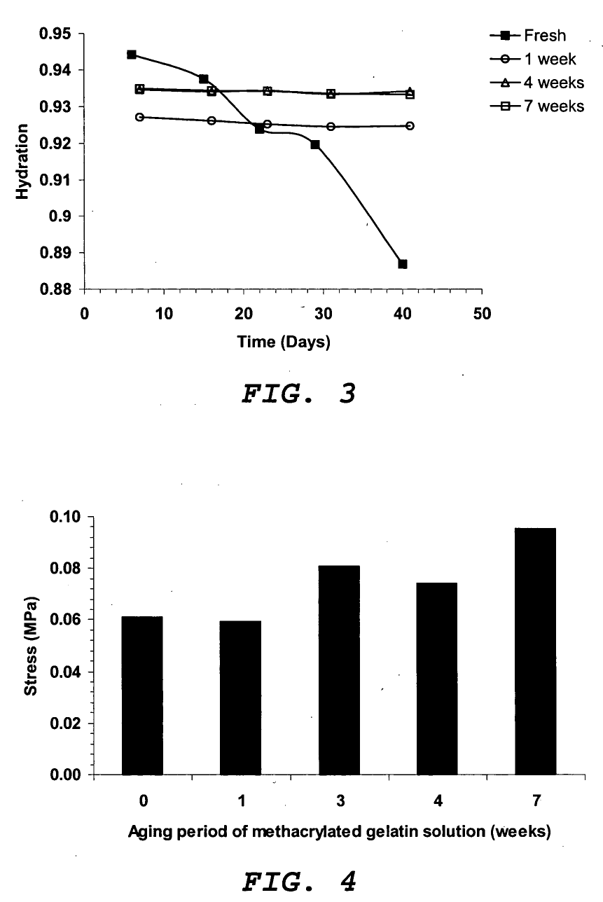

As shown in FIG. 3, IPN films prepared from aged methacrylated gelatin maintain constant hydration values for more than 40 days. In contrast, IPN films prepared from fresh (unaged) methacrylated gelatin show a continuous decline in hydration. IPN films (2 mm thick) were cut into approximately 10 mm×20 mm strips. Tensile strength was measured using a Zwick materials testing machine (TCFR005TN.A50). The bar graph of FIG. 4 shows that the tensile strength of IPN films generally increases with the use of aged methacrylated gelatin solutions.

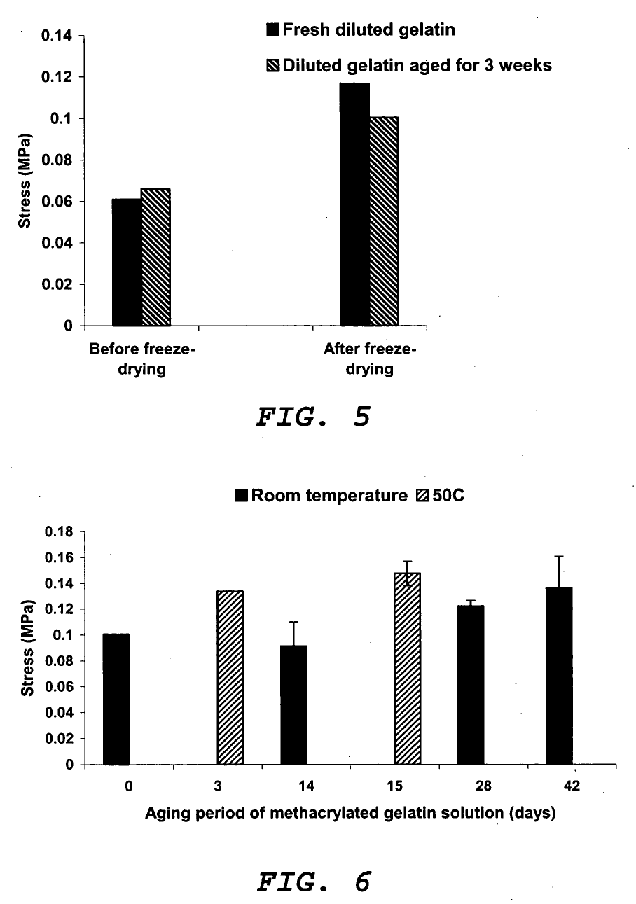

As mentioned above, 18 wt % DMSO solutions of methacrylated gelatin were diluted to 7.5 wt % and used to prepare IPN films that were subjected to freeze-drying at −70° C. FIG. 5 shows the effect of freeze drying on the tensile strength of IPN films prepared from fresh diluted methacrylated gelatin solution (black bars) and from a diluted solution previously aged at room temperature for 3 weeks (hatched bars). The IPN film subjected to freeze-drying showed a higher strength. Tensile strength tests were also performed on IPN films prepared from 7.5% methacrylated gelatin solutions aged at room temperature for 0, 14, 28 and 42 days (black bars in FIG. 6), or for 3 or 15 days at 50° C. (hatched bars in FIG. 6). The tests were performed on films immersed for 4 days in 50% bovine serum at 37° C. shortly after completion of the freeze-drying procedures. The error bars are means±standard deviation (n=3). The effect of aging on tensile strength occurs more rapidly for the methacrylated gelatin solution aged at 50° C. than the solution aged at room temperature.

Thus, it is seen that IPN films made using methacrylated gelatin solution stored for an extended period in DMSO have significantly smaller domain sizes than films made from fresh methacrylated gelatin solution. Aging also increases the stability and tensile strength of IPN films, as does heating of the methacrylated gelatin solution during aging and freeze-drying of the film.

1. A method of producing an interpenetrating polymer network comprising the steps of:
forming a first solution of a biocompatible, hydrophilic first component selected from the group consisting of a biopolymer, a synthetic polymer and monomers and prepolymers of said biopolymer and synthetic polymer;
allowing said first solution of said first component to age for an extended period of time;
forming a second solution of aged first component and monomers and prepolymers of said biopolymer and synthetic polymer, and a second component selected from the group consisting of a biocompatible elastomer and monomers and prepolymers thereof in a common solvent; and
forming a film, fiber, bead or mesh from the second solution.

2. The method of claim 1, wherein a hydrophilic polymer and an elastomer selected from the group consisting of silicone, polyurethane and a modified polyurethane are dissolved in a common solvent to form a solution; cross-linking of at least one of the components is initiated, and the resulting resin solution is shaped to form a film or fiber.

3. The method of claim 2, wherein the resulting solution is shaped to form a three-dimensional open mesh.

4. The method of claim 2, wherein the first component is selected from the group consisting of a polyvinyl alcohol, polyhydroxymethacrylate, polyethylene oxides, acrylamides, hydrophobically modified hydrogels, collagen, gelatin, fibronectin, cellulose, hydroxypropyl cellulose, hydroxypropylmethyl cellulose, methyl cellulose, ethyl cellulose, carboxymethyl cellulose, carboxyethyl cellulose, modified gelatin, alginate and oxidized cellulose, and the second component is selected from the group consisting of polyurethane-polydimethylsiloxane copolymers, vinyl containing siloxanes, polymethylhydrosiloxanes, polyethylene-polyvinylacetate, polypropylene oxide, polytetramethylene oxide, polytetrafluoroethylene, polystyrene and HydroThane.

5. The method of claim 1 wherein the solution of the first component is heated during aging.

6. The method of claim 1 including the step of freeze-drying the film, fiber, bead or mesh to increase the mechanical strength thereof.

7. The method of claim 1, wherein the first component is gelatin and the second component is HydroThane.

8. The method of claim 7, wherein gelatin is subjected to methacrylation to produce methacrylated gelatin; the methacrylated gelatin and HydroThane are dissolved in a common solvent to form a solution; and the solution is UV-irradiated to effect cross-linking, whereby a methacrylated gelatin-HydroThane interpenetrating polymer network is produced.

9. The method of claim 8, wherein the methacrylated gelatin is aged for 1 to 8 weeks before being dissolved with HydroThane in a common solvent.

10. The method of claim 8, wherein the methacrylated gelatin is aged for 4 to 8 weeks before being dissolved with HydroThane in a common solvent.

11. The method of claim 9, wherein a solution of the methacrylated gelatin is heated during aging.

12. The method of claim 11, wherein the solution of methacrylated gelatin is heated at 50° C. for at least 3 to 24 days before being mixed with a solution of HydroThane.

13. The method of claim 9, wherein methacrylated gelatin-HydroThane interpenetrating polymer network is freeze-dried to increase the mechanical strength of the polymer network.

14. The method of claim 9, wherein the methacrylated gelatin-HydroThane interpenetrating polymer network is formed into a film, and the film is freeze dried at −70° C., whereby the mechanical strength of the film is increased.

15. A method of producing an interpenetrating polymer network comprising the steps of:
forming a first solution of a biocompatible, hydrophilic first component selected from the group consisting of a biopolymer, a synthetic polymer and monomers and prepolymers of said biopolymer and synthetic polymer;
forming a second solution of aged first component and monomers and prepolymers of said biopolymer and synthetic polymer, and a second component selected from the group consisting of a biocompatible elastomer and monomers and prepolymers thereof in a common solvent;
forming a product selected from the group consisting of a film, fiber, bead and a mesh from the second solution; and
freeze drying the product to increase the mechanical strength thereof.

16. The method of claim 15, wherein the first component is methacrylated gelatin, the second component is HydroThane and the product is a methacrylated gelatin-HydroThane interpenetrating polymer network.

17. The method of claim 16, wherein the methacrylated gelatin-HydroThane interpenetrating polymer network is formed into a film, and the film is freeze-dried at −70° C., whereby the mechanical strength of the film is increased.

18. The method of claim 7, including the steps of:
subjecting gelatin to methacrylation to produce methacrylated gelatin;
forming a concentrated solution of the methacrylated gelatin;
aging the concentrated solution of the methacrylated gelatin for 1 to 3 weeks;
diluting the aged concentrated solution to yield an aged dilute solution of methacrylated gelatin;
mixing the aged dilute solution and a solution of HydroThane and effecting cross-linking to produce a methacrylated gelatin-HydroThane interpenetrating polymer network.

19. The method of claim 18, wherein the concentrated solution has a concentration of 18 wt % methacrylated gelatin, and the dilute solution has a concentration of 7.5 wt % methacrylated gelatin.
